(19) United States
(12) Patent Application Publication
(10) Pub. No.: US 2011/0277312 A1
(43) Pub. Date: Nov. 17, 2011

(54) Oil mitigation device for reducing oil levels in the Gulf of Mexico

(76) Inventor: William Redvers Belisle, New Orleans, LA (US)

(21) Appl. No.: 12/800,445

(22) Filed: May 17, 2010

(51) Int. Cl. B23P 17/00

(52) U.S. Cl. 29/592

(57) ABSTRACT

A oil permeable-walled Gulf of Mexico oil spill and leak collection device is presented. The invention includes a chemical process-walled collection device. The device is 1×10⁻⁵ to 1×10⁵ feet long fortified pipe with 1×10⁻² cm to 1×10⁵ feet diameters including 100 ft diameter with walls externally permeable to oil. The thickness of the wall may vary from 1×10⁻⁵ cm to 1×10⁵ feet including 6 in thick. Gulf of Mexico oil coming in contact with the submerged device will be permeate through the oil permeable walls of the device and collected in the fortified pipe.

### CROSS-REFERENCE TO RELATED APPLICATIONS

1. Huntley, S., Gareth, D, Olsvik, O., Rytter, E., Sogge, J., and Stetsen, J., 2010. “Method of oil recovery from an oil field” (U.S. Pat. No. 7,673,685).
2. Pabalan, R. T., Woodward, G., Dahanayake, M. and Adam, H., 2010. “Method for separation crude oil emulsions” (U.S. Pat. No. 7,671,099).
3. Fukuda, N., Hayata, S., Oyama, T., and Ino, A., 2010. “Adsorbent, method for producing same, and method for processing oil-containing waste water:” (U.S. Pat. No. 7,666,306).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention/Technical Field

The following is ‘A statement of the field of art to which the invention pertains’:
1. U.S. Class 166 Field of Search: 166/266; 166/90.1
2. U.S. Class 516 Field of Search: 516/181, 516/182, 516/191
3. U.S. Class 210 Field of Search: 210/660, 210/691, 210/693, 210/694, 502/416, 502/418

2. Description of Related Art

Huntley et al. (2010) describe a method of using nitrogen from an air separation unit to deliver oxygen and enriched air to a plant to increase oil recovery. Pabalan et al. (2010) describe a method of using a demulsifier comprising a terpene alkoxylate for breaking an emulsion of oil and water. Fukuda et al. (2010) describe a calcined coke surface area of 20 m.sup.2/g or less to adsorb oil in oil-containing wastewater when the oil-containing wastewater is an emulsion or low concentration of oil.

The prior inventions do not describe direct oil leak suction, absorption and chemical reaction of dense oil for collection from deep gulf of Mexico or other system waters as does the present invention.

### BRIEF SUMMARY OF THE INVENTION

It is the objective of the invention to collect leaking oil directly and indirectly from near a leaking oil opening deep in and near the floor of the Gulf of Mexico. The claimed invention provides an oil collection technology that can be used to collect an additional degree oil that has been spilled or leaked deep in the Gulf of Mexico compared to presently available technologies. The technique uses forced upward oil motion, suction, porous media and chemical oil collection methods.

### BRIEF DESCRIPTIONS OF THE SEVERAL VIEWS OF THE DRAWINGS

The present invention will be more fully understood by references to the following brief description thereof when read in conjunction with the attached drawings, and wherein:

FIG. 1. A simple side view diagram of the forced upward oil motion, suction, permeable membrane porous media and chemical oil collection pipe, chemical processing section, and cone head near an oil leak on the Gulf of Mexico floor and near a dense oil area of the Gulf of Mexico between 1×10⁻⁵ to 1×10⁵ feet from the Gulf surface.

FIG. 2. A simple side view diagram of the ‘oil in Gulf—permeable membrane porous and chemical treatment media’ pipe with the fortified pipe walls and bottom made of such materials for the collection of dense oil from deep Gulf of Mexico waters.

FIG. 3. A cross-sectional view of the oil permeable extremity fortified pipe wall.

### DETAILED DESCRIPTION OF THE INVENTION

Present methods of mitigating oil from the Gulf of Mexico appear to include such methods as deep water capping of the oil leak at the floor of the Gulf, chemical dispersants, booms, sand and other on-land physical barriers and Gulf surface sorption materials. The present invention provides a method of mitigating oil from between the Gulf surface and floor using oil collection techniques and equipment including oil permeating and chemical processes about varying diameter, 1×10⁻⁵ to 1×10⁵ feet long fortified piping.

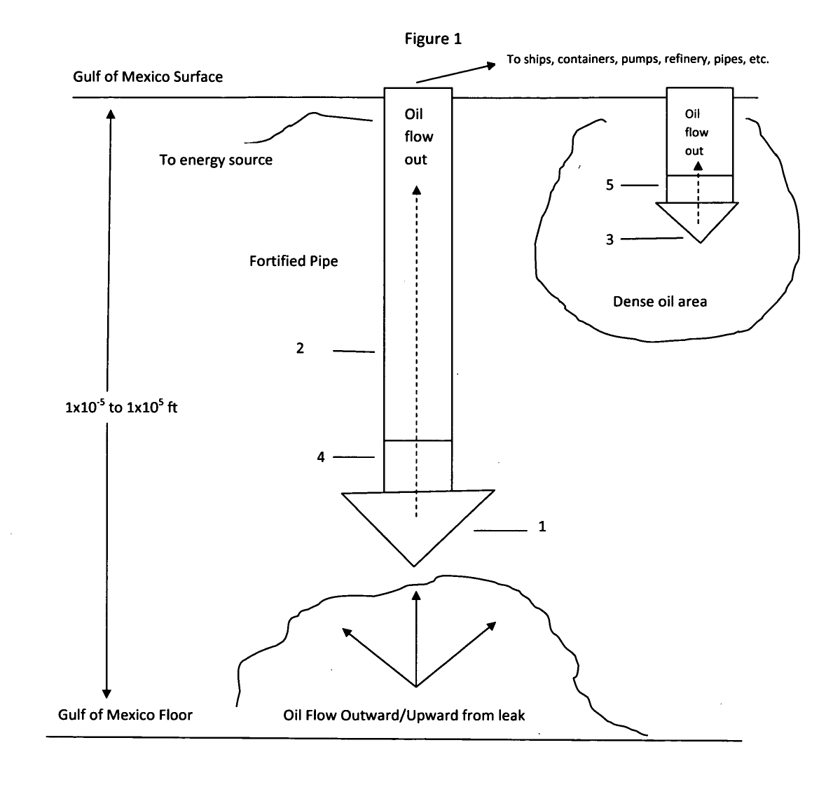

The invention is made by constructing a 1×10⁻⁵ to 1×10⁵ feet long fortified pipe, 2, with 1×10⁻² cm to 1×10⁵ feet diameters including 100 ft diameter with walls externally permeable to oil. The thickness of the wall, 6, may vary from 1×10⁻⁵ cm to 1×10⁵ feet including 6 in thick (see FIG. 1). A 6 in thick oil permeable material is constructed to cover the external wall of the fortified pipe. The internal wall of the fortified piping may also be constructed with 6 in of oil permeable material. The oil permeable material may also be made within the fortified pipe wall. Holes and oil entering points are made along the fortified piping to allow oil within the Gulf of Mexico to come in contact with the invention external oil permeable walls, move into and through the permeable material into the inside of the fortified pipe. Gulf oil contacting the invention will permeate through the external pipe material and into the fortified pipe for collection or into the chemical processing unit, 4 and 5, within the fortified pipe wall. Vacuum pumps positioned at the top and along the fortified pipe provide suction within the fortified pipe contributing to the movement of the oil external to the pipe and oil permeable material to move into and through the permeable material into the fortified pipe for collection, storage, refinement and other treatment. External pressure from the Gulf depth will provide a degree of pressure contributing to the movement of Gulf oil into the permeable material and fortified pipe. The bottom of the fortified piping is shaped like a pointed cone, 1 and 3, and may be made onto the bottom of the pipe. The bottom section of the pipe is made as is the fortified pipe with oil permeable material. The pointed cone-shaped bottom of the fortified pipe may then positioned directly into out-gushing/pouring oil from the leak on the Gulf floor or positioned directly into dense oil areas of the Gulf. Oil collected within the fortified pipe may be piped to ships, containers, refineries, treatment and other locations.

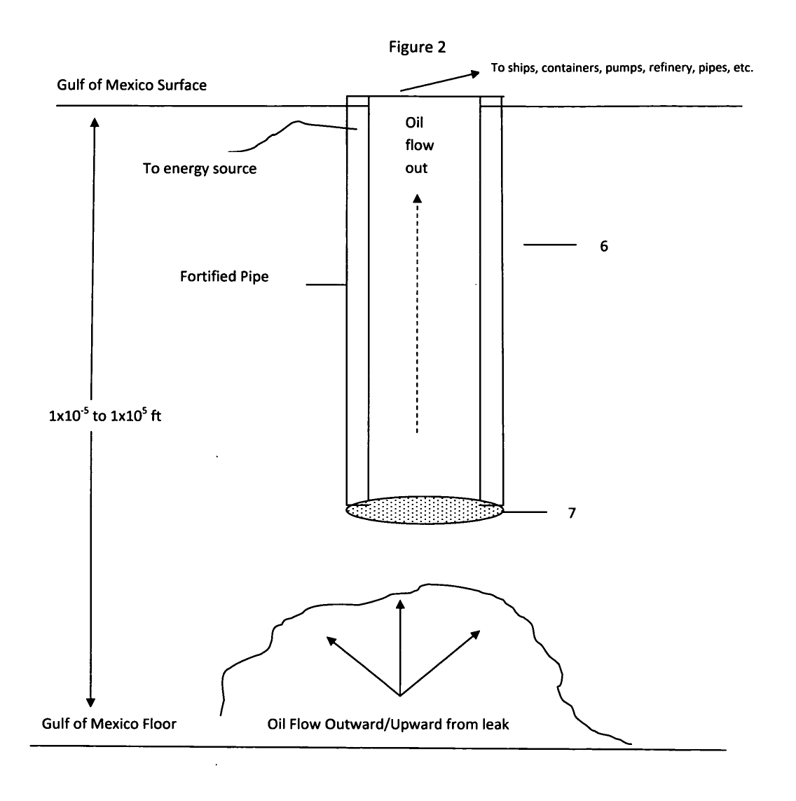

The invention is made by constructing a 1×10⁻⁵ to 1×10⁵ feet long fortified pipe, 2, with 1×10⁻² cm to 1×10⁵ feet diameters including 100 ft diameter with walls externally permeable to oil. The thickness of the wall, 6, may vary from 1×10⁻⁵ cm to 1×10⁵ feet including 6 in thick (see FIG. 2). A 6 in thick oil permeable material is constructed to cover the external wall of the fortified pipe. The internal wall of the fortified piping may also be constructed with 6 in of oil permeable material. The oil permeable material may also be made within the fortified pipe wall. Holes an oil entering points are made along the fortified piping to allow oil within the Gulf of Mexico to come in contact with the invention external oil permeable walls, move into and through the permeable material into the inside of the fortified pipe. Gulf oil contacting the invention will permeate through the external pipe material and into the fortified pipe for collection or into the chemical processing unit, 4 and 5, within the fortified pipe wall. Vacuum pumps positioned at the top and along the fortified pipe provide suction within the fortified pipe contributing to the movement of the oil external to the pipe and oil permeable material to move into and through the permeable material into the fortified pipe for collection, storage, refinement and other treatment. External pressure from the Gulf depth will provide a degree of pressure contributing to the movement of Gulf oil into the permeable material and fortified pipe. The bottom of the fortified piping is the rounded end of the piping formed as in a single piece of piping or a flat-type seal, 7, may be made onto the bottom of the pipe. The bottom section of the pipe is made as is the fortified pipe with oil permeable material. Oil collected within the fortified pipe may be piped to ships, containers, refineries, treatment and other locations.

The external and internal walls of the fortified pipe may also be made with chemical oil treatment processes built within the fortified pipe walls. The chemical oil treatment devices may also be constructed on the external pipe wall and may also be constructed on the external walls of the oil permeable material. Gulf oil coming in contact with the external surface of the oil chemical treatment devices may move into the chemical treatment devices, and then into the oil permeable materials and then into the fortified pipe. Gulf oil may also move directly through the chemical treatment devices directly into the fortified pipe. The chemical treatment devices may also include such materials as enzymes.

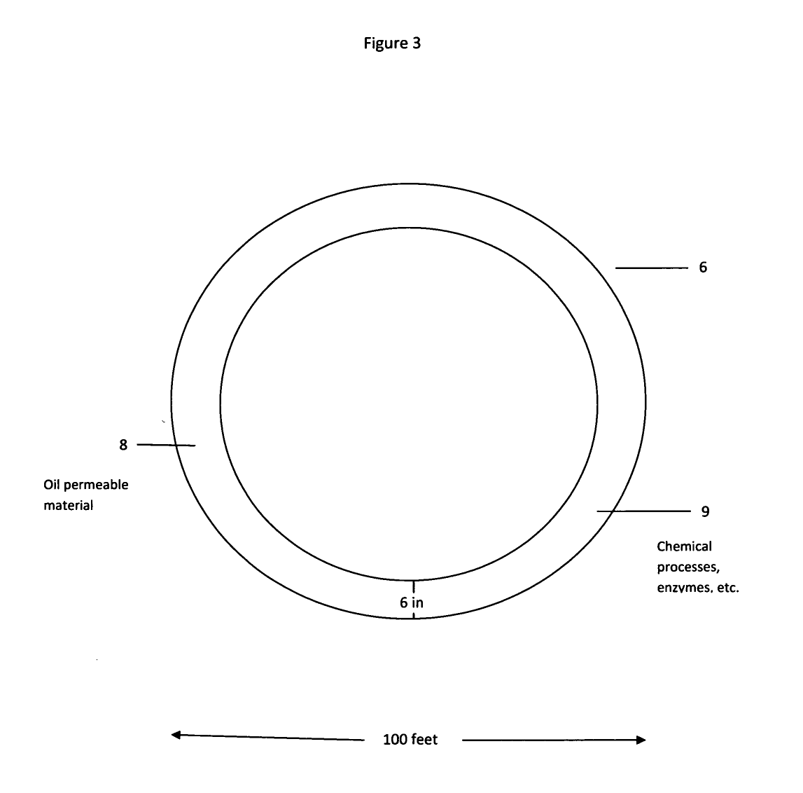

The exterior of the walls of the invention/fortified pipe, 6, are made of enclosed and non-enclosed semi-permeable material or membrane, 8, with the encasement allowing the Gulf oil access to the semi-permeable material (see FIG. 3). The semi-permeable material may vary in type and may include, but are not limited to such materials as anionic surfactant-like materials and other materials and polymeric skins.

I claim:

1. A method for making a permeable and chemical process collection Gulf of Mexico oil spill and leak mitigation device comprised of:
making a 1×10⁻⁵ to 1×10⁵ feet long fortified pipe with 1×10-2 cm to 1×105 feet diameters including 100 ft diameter with walls externally permeable to oil,
the thickness of the wall may vary from 1×10⁻⁵ cm to 1×10⁵ feet including 6 in thick,
a 6 in thick oil permeable material is constructed to cover the external wall of the fortified pipe.

2. The method according to claim 1, wherein the fortified pipe may be made of steel, iron, polymer, plastic, wood, metal, rigid materials, flexible materials, and combinations of the same.

3. The method according to claim 1, wherein the oil permeable material may also be made within the fortified pipe wall.

4. The method according to claim 1, wherein holes and oil entering points are made along the fortified piping.

5. The method according to claim 1, wherein vacuum pumps may be positioned at the top and along the fortified pipe to provide suction within the fortified pipe.

6. The method according to claim 1, wherein the bottom of the fortified piping is shaped like a pointed cone and may be made onto the bottom of the pipe and the bottom section of the pipe is made as is the fortified pipe with oil permeable material.

7. The method according to claim 1, wherein the bottom of the fortified piping is the rounded end of the piping formed as in a single piece of piping or a flat-type seal may be made onto the bottom of the pipe.

8. A method for making a permeable and chemical process collection Gulf of Mexico oil spill and leak mitigation device comprised of:
making a 1×10⁻⁵ to 1×10⁵ feet long fortified pipe with 1×10-2 cm to 1×105 feet diameters including 100 ft diameter with walls externally permeable to oil,
the thickness of the wall may vary from 1×10⁻⁵ cm to 1×10⁵ feet including 6 in thick,
a 6 in thick oil permeable material is constructed to cover the external wall of the fortified pipe.

9. The method according to claim 7, wherein the external and internal walls of the fortified pipe may be made with chemical oil treatment processes built within the fortified pipe walls.

10. The method according to claim 7, wherein the chemical oil treatment devices may also be constructed on the external pipe wall and may also be constructed on the external walls of the oil permeable material.

11. The method according to claim 7, wherein the chemical treatment devices may also include such materials as enzymes.

12. The method according to claims 1 and 7, wherein the exterior of the walls of the invention and fortified pipe are made of enclosed and non-enclosed semi-permeable material or membrane with the enclosure allowing the Gulf oil access to the semi-permeable material.

13. A method for making a permeable and chemical process collection Gulf of Mexico oil spill and leak mitigation device comprised of:
making a 1×10⁻⁵ to 1×10⁵ feet long fortified pipe with 1×10-2 cm to 1×105 feet diameters including 100 ft diameter with walls externally permeable to oil,
the thickness of the wall may vary from 1×10⁻⁵ cm to 1×10⁵ feet including 6 in thick,
a 6 in thick oil permeable material is constructed to cover the external wall of the fortified pipe.

14. The method according to claim 7, wherein the device may be used to encase and enclose high oil concentration areas in the Gulf of Mexico.

15. The method according to claims 1, 7, 12, wherein the semi-permeable material may vary in type and may include, but are not limited to such materials as anionic surfactant-like materials, polymeric skins and other materials.
